(19) United States
(12) Patent Application Publication
(10) Pub. No.: US 2022/0318631 A1
(43) Pub. Date: Oct. 6, 2022

(54) DEEP NEURAL NETWORK WITH REDUCED PARAMETER COUNT

(71) Applicant: Nokia Technologies Oy, Espoo (FI)

(72) Inventors: Iraj Saniee, New Providence, NJ (US); Yihao Zhang, Chatham, NJ (US); Bradley Magnetta, New Haven, CT (US)

(21) Appl. No.: 17/221,962

(22) Filed: Apr. 5, 2021

(51) Int. Cl. G06N 3/08; G06N 3/04

(52) U.S. Cl. CPC G06N 3/082; G06N 3/04

(57) ABSTRACT

Systems, methods, and software of processing Deep Neural Networks (DNN) comprising a plurality of nodes with connections between the nodes. In one embodiment, a system initializes the DNN by assigning initial values to weights associated with the connections, and identifies an initial subset of the connections randomly selected from the DNN. The initial subset after training with a training dataset has a training accuracy below an accuracy threshold. The system performs a growth process by adding additional connections from the DNN to the initial subset to generate a qualified subset of the connections. The qualified subset of the connections after training with the training dataset has a training accuracy that reaches the accuracy threshold.

### TECHNICAL FIELD

This disclosure is related to the field of machine learning, and in particular, to Deep Neural Networks (DNNs).

### BACKGROUND

A DNN is a type of machine learning that uses a set of connections modeled after the connections of neurons in the human brain to learn from examples. A DNN is represented as a hierarchical (layered) organization of nodes similar to the neurons with connections to other nodes. Inputs are primitive of objects to be classified, and output the set of classes aimed for. Each node in a hidden layer receives an input from nodes in a previous layer, combines the signals from nodes in the previous layer via a non-linear function, and passes its output to nodes in the next layer. The connection between two nodes of successive layers has an associated weight that defines the influence of the input to the non-linear function in the node that generates its output for the next node. During training of a DNN, training data (what input gives rise to what output) is fed to the DNN, and the weights of the connections are updated or optimized until the DNN has a desired accuracy. For example, if the DNN is being trained for object recognition, a large number of labeled images may be fed to the DNN until the DNN is able to produce sufficiently accurate classifications of the images on the training dataset.

DNNs may be used to carry out complex tasks such as machine vision, object recognition, disease diagnoses, bioinformatics, drug design, natural language processing, machine translation, etc. Modern computing power allows DNNs to grow deeper and bigger having millions of adjustable parameters (i.e., weights). However, a DNN having large parameter counts may require a system to have large storage and computational resources.

### SUMMARY

Described herein is a system and associated method of extracting a subnetwork from a DNN. As described above, a fully-connected DNN includes a plurality of nodes arranged in layers, with full connections between the nodes in consecutive layers. A system as described herein selects a minimal set of connections from the DNN (i.e., unmasked connections), and masks the remaining connections. The minimal set of unmasked connections is expected to have a training accuracy below an accuracy threshold. The system builds up from the minimal set of unmasked connections to discover a subnetwork that has the desired training accuracy but has a much smaller parameter count than the DNN. The system may also prune the subnetwork to further reduce the parameter count. One technical benefit is the resultant subnetwork has far lower storage and processing requirements than the full DNN, and may thus have applications in resource-limited devices, such as a mobile phone or a robot.

One embodiment comprises a subnetwork discovery system for a DNN comprising a plurality of nodes with connections between the nodes. The subnetwork discovery system comprises at least one processor and memory. The processor causes the subnetwork discovery system to initialize the DNN by assigning initial values to weights associated with the connections, and identify an initial subset of the connections randomly selected from the DNN. The initial subset after training with a training dataset has a training accuracy below an accuracy threshold. The processor causes the subnetwork discovery system to perform a growth process by adding additional connections from the DNN to the initial subset to generate a qualified subset of the connections. The qualified subset of the connections after training with the training dataset has a training accuracy that reaches the accuracy threshold.

In another embodiment, the processor causes the subnetwork discovery system to perform a pruning process to remove a portion of the connections from the qualified subset to generate a pruned subset of the connections. The pruned subset after training with the training dataset has a training accuracy that reaches the accuracy threshold.

In another embodiment, for the pruning process, the processor causes the subnetwork discovery system to reset the weights of the connections in the qualified subset to the initial values, optimize the weights of the connections in the qualified subset based on the training dataset, and remove a portion of the connections from the qualified subset based on a prune percentage.

In another embodiment, the processor causes the subnetwork discovery system to perform multiple iterations of the pruning process.

In another embodiment, the initial subset contains an initial percentage of the connections in the DNN, and the qualified subset contains a target percentage of the connections of the DNN. For the growth process, the processor causes the subnetwork discovery system to use a binary search to identify the target percentage for the qualified subset.

In another embodiment, for the binary search, the processor causes the subnetwork discovery system to:
(a) identify the initial percentage as a lower bound of a search interval for the binary search;
(b) select an upper bound of the search interval for the binary search as an upper bound percentage that is larger than the initial percentage;
(c) select an intermediate percentage for the search interval;
(d) add additional connections from the DNN to the initial subset based on the intermediate percentage to form a candidate subset of the connections;
(e) reset the weights of the connections in the candidate subset to the initial values;
(f) optimize the weights of the connections in the candidate subset based on the training dataset;
(g) determine a training accuracy of the candidate subset;
(h) narrow the search interval to an upper half of the search interval when the training accuracy is below the accuracy threshold; and
(i) narrow the search interval to a lower half of the search interval when the training accuracy meets the accuracy threshold; and
repeat (c)-(i) to converge on the target percentage.

In another embodiment, for the growth process, the processor causes the subnetwork discovery system to select a growth percentage, add additional connections to the initial subset based on the growth percentage to form a candidate subset of the connections, reset the weights of the connections in the candidate subset to the initial values, optimize the weights of the connections in the candidate subset based on the training dataset, determine the training accuracy of the candidate subset, identify the candidate subset as the qualified subset when the training accuracy reaches the accuracy threshold, and initiate another iteration of the growth process when the training accuracy is below the accuracy threshold.

In another embodiment, the initial subset contains an initial percentage of the connections in the DNN. The processor causes the subnetwork discovery system to select the initial percentage based on a ratio of a size of the training dataset, and a total number of the weights in the DNN.

Another embodiment comprises a method of processing a DNN comprising a plurality of nodes with connections between the nodes. The method comprises initializing the DNN by assigning initial values to weights associated with the connections, and identifying an initial subset of the connections randomly selected from the DNN. The initial subset after training with a training dataset has a training accuracy below an accuracy threshold. The method further comprises performing a growth process by adding additional connections from the DNN to the initial subset to generate a qualified subset of the connections. The qualified subset of the connections after training with the training dataset has a training accuracy that reaches the accuracy threshold.

In another embodiment, the method further comprises performing a pruning process to remove a portion of the connections from the qualified subset to generate a pruned subset of the connections. The pruned subset after training with the training dataset has a training accuracy that reaches the accuracy threshold.

In another embodiment, for the pruning process, the method further comprises resetting the weights of the connections in the qualified subset to the initial values, optimizing the weights of the connections in the qualified subset based on the training dataset, and removing a portion of the connections from the qualified subset based on a prune percentage.

In another embodiment, the method further comprises performing multiple iterations of the pruning process.

In another embodiment, the initial subset contains an initial percentage of the connections in the DNN, and the qualified subset contains a target percentage of the connections of the DNN. For the growth process, the method uses a binary search to identify the target percentage for the qualified subset.

In another embodiment, for the binary search, the method further comprises:
(a) identifying the initial percentage as a lower bound of a search interval for the binary search;
(b) selecting an upper bound of the search interval for the binary search as an upper bound percentage that is larger than the initial percentage;
(c) selecting an intermediate percentage for the search interval;
(d) adding additional connections from the DNN to the initial subset based on the intermediate percentage to form a candidate subset of the connections;
(e) resetting the weights of the connections in the candidate subset to the initial values;
(f) optimizing the weights of the connections in the candidate subset based on the training dataset;
(g) determining a training accuracy of the candidate subset;
(h) narrowing the search interval to an upper half of the search interval when the training accuracy is below the accuracy threshold; and
(i) narrowing the search interval to a lower half of the search interval when the training accuracy meets the accuracy threshold; and
repeating (c)-(i) to converge on the target percentage.

In another embodiment, for the growth process, the method further comprises selecting a growth percentage, adding additional connections to the initial subset based on the growth percentage to form a candidate subset of the connections, resetting the weights of the connections in the candidate subset to the initial values, optimizing the weights of the connections in the candidate subset based on the training dataset, determining the training accuracy of the candidate subset, identifying the candidate subset as the qualified subset when the training accuracy reaches the accuracy threshold, and initiating another iteration of the growth process when the training accuracy is below the accuracy threshold.

In another embodiment, the initial subset contains an initial percentage of the connections in the DNN, and the method further comprises selecting the initial percentage based on a ratio of a size of the training dataset, and a total number of the weights in the DNN.

Another embodiment comprises a system for processing a DNN comprising a plurality of nodes with connections between the nodes. The system comprises a means for initializing the DNN by assigning initial values to weights associated with the connections. The system further comprises a means for identifying an initial subset of the connections randomly selected from the DNN. The initial subset after training with a training dataset has a training accuracy below an accuracy threshold. The system further comprises a means for performing a growth process by adding additional connections from the DNN to the initial subset to generate a qualified subset of the connections. The qualified subset of the connections after training with the training dataset has a training accuracy that reaches the accuracy threshold. The system may further comprise a means for performing a pruning process to remove a portion of the connections from the qualified subset to generate a pruned subset of the connections. The pruned subset after training with the training dataset has a training accuracy that reaches the accuracy threshold.

Other embodiments may include computer readable media, other systems, or other methods as described below.

The above summary provides a basic understanding of some aspects of the specification. This summary is not an extensive overview of the specification. It is intended to neither identify key or critical elements of the specification nor delineate any scope of the particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments of the invention are now described, by way of example only, and with reference to the accompanying drawings. The same reference number represents the same element or the same type of element on all drawings.

FIG. 1 illustrates a DNN.

FIG. 2 illustrates a node of a DNN.

FIG. 3 is a block diagram illustrating discovery of a trainable subnetwork in a DNN in an illustrative embodiment.

FIG. 4 is a block diagram of a subnetwork discovery system in an illustrative embodiment.

FIG. 5 is a flow chart illustrating a method of discovering a trainable subnetwork from a DNN in an illustrative embodiment.

FIG. 6 is a block diagram illustrating a subnetwork discovery system operating on a DNN in an illustrative embodiment.

FIG. 7 is a flow chart illustrating a growth process in an illustrative embodiment.

FIG. 8 is a flow chart illustrating a growth process in an illustrative embodiment.

FIG. 9 is a flow chart illustrating a pruning process in an illustrative embodiment.

### DESCRIPTION OF EMBODIMENTS

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

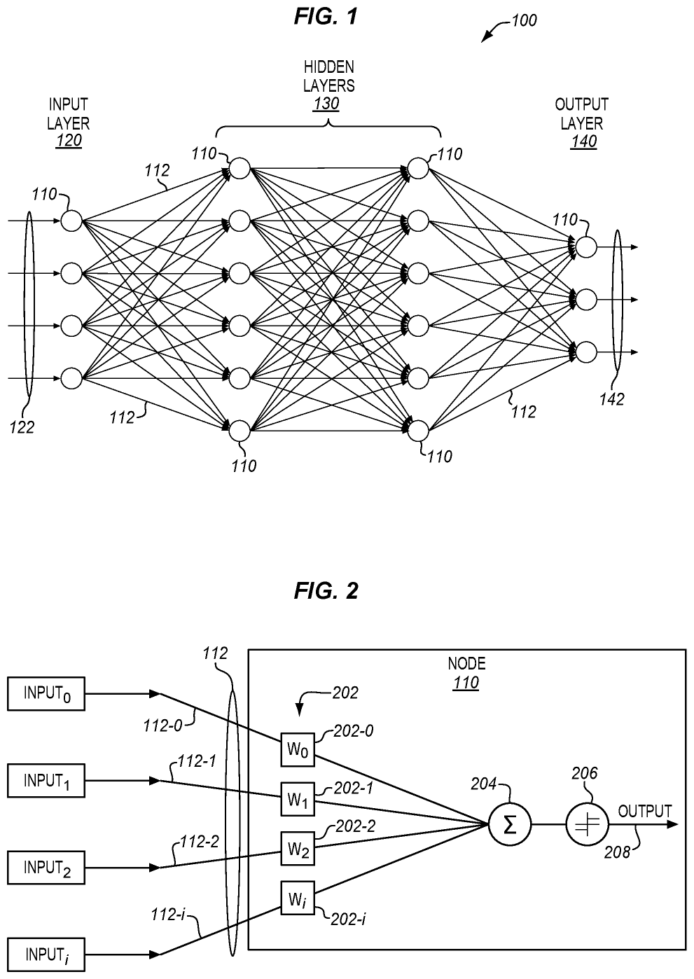

FIG. 1 illustrates a DNN 100. In one example, DNN 100 may comprise a fully-connected feed-forward DNN. DNN 100 (also referred to as an Artificial Neural Network (ANN)) is a computational model comprised of hundreds, or thousands, of nodes 110. A node 110 is a computational unit, loosely patterned on a neuron in the human brain, which fires when it encounters sufficient stimuli. Nodes 110 are arranged in a series of layers comprised of an input layer 120, one or more hidden layers 130, and an output layer 140. The output from one layer is the input to a subsequent layer starting from input layer 120, through one or more hidden layers 130, and ending at output layer 140. Input layer 120 includes nodes 110 (also referred to as input nodes) that receive input data 122 from the outside world into DNN 100. The nodes 110 in the input layer 120 generally do not perform computations, but pass the input data 122 to the adjacent hidden layer 130. A hidden layer 130 includes nodes 110 (also referred to as hidden nodes) that receive input from nodes 110 in a preceding layer (i.e., input layer 120 or a preceding hidden layer), perform computations, and generate outputs. The nodes 110 in a hidden layer 130 are referred to as “hidden” as they have no direct connection with the outside world. Output layer 140 includes nodes 110 (also referred to as output nodes) that receive input from nodes 110 in a preceding hidden layer 130, perform computations, and generate output. The output of the nodes 110 in output layer 140 represent the final output 142 from DNN 100 to the outside world. The final output 142 may be a classification, a prediction, etc.

Nodes 110 from adjacent layers have connections 112 or edges between them. DNN 100 may be fully-connected, which means every node 110 in one layer is connected every node 110 in the previous, adjacent layer. The connection 112 between two successive nodes 110 has an associated weight which defines the influence or significance of the input on a connection 112.

FIG. 2 illustrates a node 110 of DNN 100. Node 110 may represent a hidden node in hidden layer 130 or an output node in output layer 140. In this example, node 110 has a plurality of connections 112 with nodes 110 of a preceding layer (not shown), and receives input over the connections 112. More particularly, node 110 receives input₀ over connection 112-0, receives inputᵢ over connection 112-1, receives input₂ over connection 112-2, and receives input, over connection 112-i. There is a weight 202 associated with each connection 112. More particularly, weight 202-0 (wₒ) is associated with connection 112-0, weight 202-1 (w₁) is associated with connection 112-1, weight 202-2 (w₂) is associated with connection 112-2, and weight 202-i (wᵢ) is associated with connection 112-i.

Node 110 also includes a net input function 204 and an activation function 206. Net input function 204 combines the input received over a connection 112 with the weight associated with the connection 112. For example, net input function 204 multiplies input₀ received over connection 112-0 with weight 202-0 associated with connection 112-0. The weight 202 associated with a connection 112 therefore amplifies or dampens the input received over the connection 112. Net input function 204 then sums the input-weight product, and transfers the sum to activation function 206. Activation function 206 mimics a switch in determining whether and to what extent that signal should progress further through DNN 100 to affect the final output 142. For example, activation function 206 may compare the sum from net input function 204 to a threshold. When the sum is greater than or equal to the threshold, activation function 206 may “activate” and transfer the sum as output 208 over connections 112 to successive nodes 110. When the sum is less than the threshold, activation function 206 does not “activate” and does not transfer output 208 to the successive nodes 110. The configuration of node 110 as illustrated in FIG. 2 is one example, and nodes 110 of DNN 100 may have other configurations in other embodiments.

Training a DNN 100 can be a long and processing-intensive process, as the DNN 100 may include several thousands or millions of parameters (i.e., weights). For example, a DNN 100 may be initialized by randomly assigning initial values to the weights 202 of the connections 112. After initialization, the DNN 100 may be trained by processing samples of a training dataset to update the weights 202 of the connections 112. For example, a DNN 100 reviewing a sample in the form of an image may attempt to assign a classification to the image (e.g., “animal,” “car,” “boat,” etc.), or a DNN 100 reviewing a sample in the form of a sound may attempt to assign a classification to the sound (e.g., “voice,” “music,” “nature,” etc.). As an example of training in FIG. 1, a sample from the training dataset is input to the nodes 110 of input layer 120, and DNN 100 produces a classification or prediction for the sample as the final output 142 from output layer 140. The adjustable parameters of DNN 100 (i.e., the weights 202 of the connections 112) are then modified based on the accuracy of the output of DNN 100. For example, an optimization algorithm (e.g., stochastic gradient descent) may be used to determine the values of the weights that minimizes a cost function (generally quadratic or entropic) that measures deviation from the designated class for each input sample, and the values of the weights 202 are adjusted accordingly to “train” the DNN 100. Training in this manner proceeds for multiple samples of the training dataset so that the training accuracy of the DNN 100 reaches an accuracy threshold (e.g., 90%).

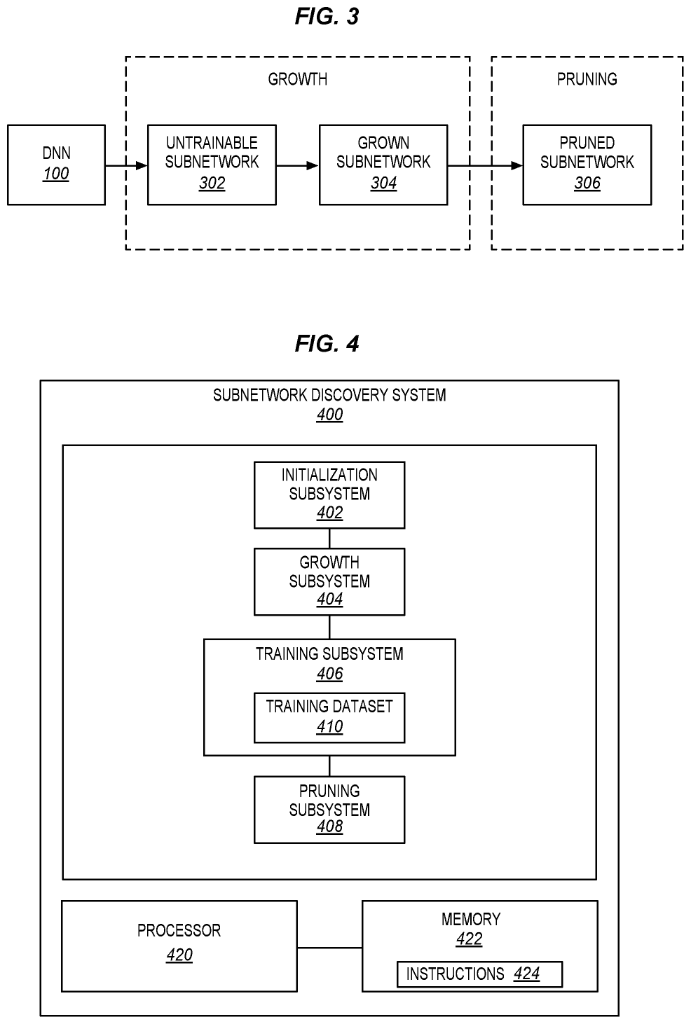

When the number of parameters in the DNN 100 is large, the training process as described above can be long and processing-intensive. To overcome this and other problems, smaller subnetworks may be discovered in a DNN 100 that, when trained, reach a desired accuracy. A subnetwork as described herein is a combination of connections 112 and associated weights 202 from a DNN 100. The connections 112 in a subnetwork may be considered unmasked, while the remaining connections 112 of DNN 100 may be considered masked. A trainable subnetwork is a combination of connections 112 and associated weights 202 that are capable of learning with a desired accuracy. FIG. 3 is a block diagram illustrating discovery of a trainable subnetwork in a DNN 100 in an illustrative embodiment. To start, a DNN 100 is initialized by randomly assigning initial values to the weights 202 of the connections 112. Thus, the weight 202 for each connection 112 of the initialized DNN 100 is assigned an initial value. After initialization, an untrainable subnetwork 302 is selected from DNN 100. An untrainable subnetwork 302 is a combination of connections 112 and associated weights 202 that are incapable of learning with a desired accuracy. In other words, untrainable subnetwork 302 is so sparse that its combination of connections 112 and associated weights 202, when trained, will not have the desired accuracy. For example, the untrainable subnetwork 302 may be selected from a small percentage of the connections 112, such as 1%, 2%, 3%, or some other minimal percentage of connections 112 from DNN 100.

A growth process is then performed to build up the untrainable subnetwork 302 by adding additional connections 112 from DNN 100 to the untrainable subnetwork 302 until a grown subnetwork 304 is discovered. Grown subnetwork 304 is considered a trainable subnetwork that, when trained, reaches the desired accuracy. Grown subnetwork 304 is more dense (i.e., has a larger number of connections 112) than untrainable subnetwork 302, but is more sparse than the DNN 100. For example, grown subnetwork 304 may comprise 6%, 12%, 15%, 20%, etc., of the connections 112 and associated weights 202 from DNN 100.

After discovering grown subnetwork 304, a pruning process may be performed on grown subnetwork 304 to remove the less influential connections 112 from grown subnetwork 304. For example, the connections 112 of grown subnetwork 304 having the smallest-magnitude weights 202 may be removed or masked, and the remaining, unpruned connections 112 form a pruned subnetwork 306. Pruned subnetwork 306 is also considered a trainable subnetwork that, when trained, reaches the desired accuracy.

FIG. 4 is a block diagram of a subnetwork discovery system 400 in an illustrative embodiment. Subnetwork discovery system 400 is a server, device, apparatus, equipment (including hardware), system, means, etc., configured to discover one or more trainable subnetworks from a DNN, such as DNN 100. In this embodiment, subnetwork discovery system 400 includes the following sub-systems: an initialization subsystem 402, a growth subsystem 404, a training subsystem 406, and a pruning subsystem 408. Initialization subsystem 402 may comprise circuitry, logic, hardware, means, etc., configured to initialize a DNN by assigning initial values to the weights of the DNN. Growth subsystem 404 may comprise circuitry, logic, hardware, means, etc., configured to build up an untrainable subnetwork 302 to discover a trainable subnetwork. Training subsystem 406 may comprise circuitry, logic, hardware, means, etc., configured to train or re-train a DNN or subnetwork based on a training dataset 410. Pruning subsystem 408 may comprise circuitry, logic, hardware, means, etc., configured to prune a subnetwork.

One or more of the subsystems of subnetwork discovery system 400 may be implemented on a hardware platform comprised of analog and/or digital circuitry. One or more of the subsystems of subnetwork discovery system 400 may be implemented on one or more processors 420 that execute instructions 424 (i.e., computer program code) stored in memory 422. Processor 420 comprises an integrated hardware circuit configured to execute instructions 424, and memory 422 is a computer readable storage medium for data, instructions 424, applications, etc., and is accessible by processor 420. Subnetwork discovery system 400 may include additional components that are not shown for the sake of brevity, such as a network interface, a user interface, internal buses, etc.

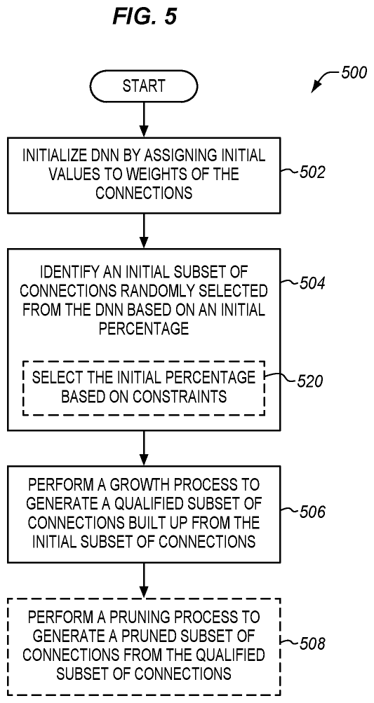

FIG. 5 is a flow chart illustrating a method 500 of discovering a trainable subnetwork from a DNN in an illustrative embodiment. The steps of method 500 will be described with reference to subnetwork discovery system 400 in FIG. 4, but those skilled in the art will appreciate that method 500 may be performed in other systems. The steps of the flow charts described herein are not all inclusive and may include other steps not shown, and the steps may be performed in an alternative order.

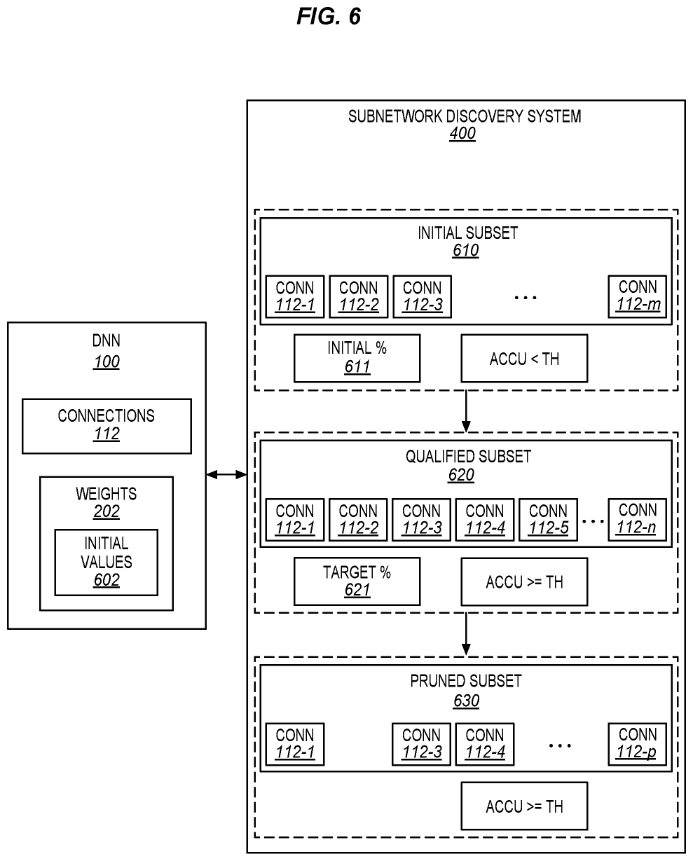

For this embodiment, it is assumed that method 500 operates on DNN 100 as shown in FIG. 1, although method 500 may operate on other DNNs. To begin, initialization subsystem 402 initializes DNN 100 by assigning initial values to the weights 202 associated with the connections 112 (step 502). FIG. 6 is a block diagram illustrating subnetwork discovery system 400 operating on DNN 100 in an illustrative embodiment. Subnetwork discovery system 400 assigns initial values 602 to the weights 202 of each of the connections 112 in DNN 100. In this embodiment, subnetwork discovery system 400 may randomly assign non-zero initial values 602 to the weights 202 of the DNN 100, such as with a uniform distribution, Gaussian distribution, etc.

To discover a trainable subnetwork, method 500 first identifies or defines an untrainable subnetwork 302 that is so sparse that it is not trainable. To do so, growth subsystem 404 identifies an initial subset of connections 112 randomly selected from the DNN 100 (step 504 of FIG. 5). An initial subset is a percentage or fraction of the total number of connections 112 in DNN 100. To identify the initial subset 610 as shown in FIG. 6, subnetwork discovery system 400 may determine, compute, or select an initial percentage 611 (or minimal percentage) of the total number of connections 112 in DNN 100. For example, the initial percentage 611 may be 2%, 4%, 6%, or another percentage as a matter of design choice. Subnetwork discovery system 400 then randomly selects connections 112 from DNN 100 based on the initial percentage 611 to form the initial subset 610 that contains the initial percentage 611 of connections 112 (indicated as CONN 112-1 thru CONN 112-m) and their associated weights 202. If the initial (random) subset 610 can be trained to meet the required accuracy, a sparse subnetwork has been discovered that meets the training accuracy requirements. This is typically a rare case. More often, the accuracy (i.e., the training accuracy) of the initial subset 610, after training, is below an accuracy threshold (ACCU<TH). Thus, either the initial subset 610 is trainable and meets required accuracy, or the initial subset 610 represents an untrainable subnetwork 302 as described in FIG. 3. When the initial subset 610 represents an untrainable subnetwork 302, the initial subset 610 establishes a baseline or starting point for discovering a trainable subnetwork from DNN 100.

The initial percentage 611 may be selected with an expectation that the training accuracy of the initial subset 610 is below the accuracy threshold, such as with experience or empirical data. For example, an observation may be that a minimal percentage (e.g., 1%, 2%, etc.) of connections 112 is expected to have a training accuracy below the accuracy threshold. Subnetwork discovery system 400 may also verify that the training accuracy of the initial subset 610 is below the accuracy threshold. To do so, training subsystem 406 may optimize the weights 202 of the connections 112 in the initial subset 610 with an optimization algorithm (e.g., stochastic gradient descent) using the training dataset 410, and determine a training accuracy of the initial subset 610. If the training accuracy of the initial subset 610 is below the accuracy threshold, then the initial subset 610 defines an untrainable subnetwork 302.

Growth subsystem 404 may select the initial percentage 611 in a variety of ways based on constraints (optional step 520). In one embodiment, the initial percentage 611 may be selected based on the size of the DNN 100, such as the number of connections 112 or weights 202. When the size of the DNN 100 is larger, the initial percentage 611 selected may be smaller, and when the size of the DNN 100 is smaller, the initial percentage 611 selected may be larger. In another embodiment, the initial percentage 611 may be selected based on the size of the training dataset 410. The size of the training dataset 410 comprises the number of samples or instances of training data in the training dataset 410. For example, assume that DNN 100 is used for image recognition. The training dataset 410 may include hundreds or thousands of instances of training images. When the size of the training dataset 410 is larger, the initial percentage 611 selected may be larger, and when the size of the training dataset 410 is smaller, the initial percentage 611 selected may be smaller. In another embodiment, the initial percentage 611 may be selected based on a ratio of the size of the training dataset 410, and a total number of weights 202 in the DNN 100. In another embodiment, the initial percentage 611 may be selected from an acceptable range, such as a range of 2-10% of the total number of connections 112 in DNN 100.

With the initial subset 610 identified, growth subsystem 404 performs a growth process to generate a qualified subset of connections 112 built up from the initial subset 610 (step 506). A qualified subset is a percentage or fraction of the total number of connections 112 in DNN 100 greater than the initial percentage 611 used to form the initial subset 610. For the growth process, growth subsystem 404 adds additional connections 112 from DNN 100 to the initial subset 610 to build up from the baseline number of connections 112 that were initially selected. To generate the qualified subset 620 as shown in FIG. 6, subnetwork discovery system 400 may determine, compute, or select a target percentage 621 of the total number of connections 112 in DNN 100. Subnetwork discovery system 400 then randomly selects additional connections 112 from DNN 100 and adds the additional connections 112 to the initial subset 610 to form the qualified subset 620 that contains the target percentage 621 of connections 112 and associated weights 202. The qualified subset 620 therefore contains the connections 112 initially selected for the initial subset 610, and the additional connections 112 (indicated as CONN 112-1 thru CONN 112-n). These connections 112 have initial values 602 assigned, which will be used in training optimization. After training, qualified subset 620 has a training accuracy that reaches the accuracy threshold (ACCU>=TH). Thus, the qualified subset 620 represents a grown subnetwork 304 as described in FIG. 3.

The growth process from the initial subset 610 to the qualified subset 620 may vary as desired. In general, the growth process adds connections 112 to the initial subset 610 to build a qualified subset 620 that reaches the accuracy threshold. In one embodiment, subnetwork discovery system 400 may use a binary search, a golden ratio search, or the like for the growth process, as is described in more detail below. In another embodiment, subnetwork discovery system 400 may iteratively add a number or percentage of additional connections 112 to the initial subset 610 for the growth process, as is described in more detail below. However, other types of growth processes are considered herein.

Discovery of the qualified subset 620 of connections 112 is beneficial in that the qualified subset 620 represents a trainable subnetwork that has an acceptable training accuracy (i.e., equal to or greater than the accuracy threshold), but has a reduced parameter count (i.e., less weights) compared to DNN 100.

For method 500, subnetwork discovery system 400 may further reduce the parameter count of the qualified subset 620 by pruning the qualified subset 620. There may be connections 112 in qualified subset 620 that are less important and can be removed with minimal effect on accuracy. Thus, pruning subsystem 408 may perform a pruning process to generate a pruned subset of connections 112 from the qualified subset 620 (optional step 508). A pruned subset is a percentage or fraction of the total number of connections 112 in DNN 100 less than the target percentage 621 used to form the qualified subset 620. For the pruning process, pruning subsystem 408 removes or masks (i.e., eliminates) a portion or number of the connections 112 from the qualified subset 620 that are determined to be less influential, to form the pruned subset 630 as shown in FIG. 6. One way to prune is based on the absolute magnitude of the weights 202 in qualified subset 620. Connections 112 in qualified subset 620 having weights 202 whose absolute value is close to zero (i.e., low in magnitude) have minimal influence on the output. Thus, subnetwork discovery system 400 may remove or mask connections 112 in qualified subset 620 having weights 202 below a pruning threshold (i.e., the smallest-magnitude weights) to form pruned subset 630. The pruned subset 630 therefore contains a reduced number of connections 112 as compared to qualified subset 620 (indicated as CONN 112-1 thru CONN 112-p where p<n). After training, pruned subset 630 has a training accuracy that also reaches the accuracy threshold (ACCU>=TH). Thus, the pruned subset 630 represents a pruned subnetwork 306 as described in FIG. 3.

Discovery of the pruned subset 630 is beneficial in that the pruned subset 630 represents a trainable subnetwork that has an acceptable training accuracy (i.e., equal to or greater than the accuracy threshold), but has even a further reduced parameter count (i.e., less weights) compared to qualified subset 620.

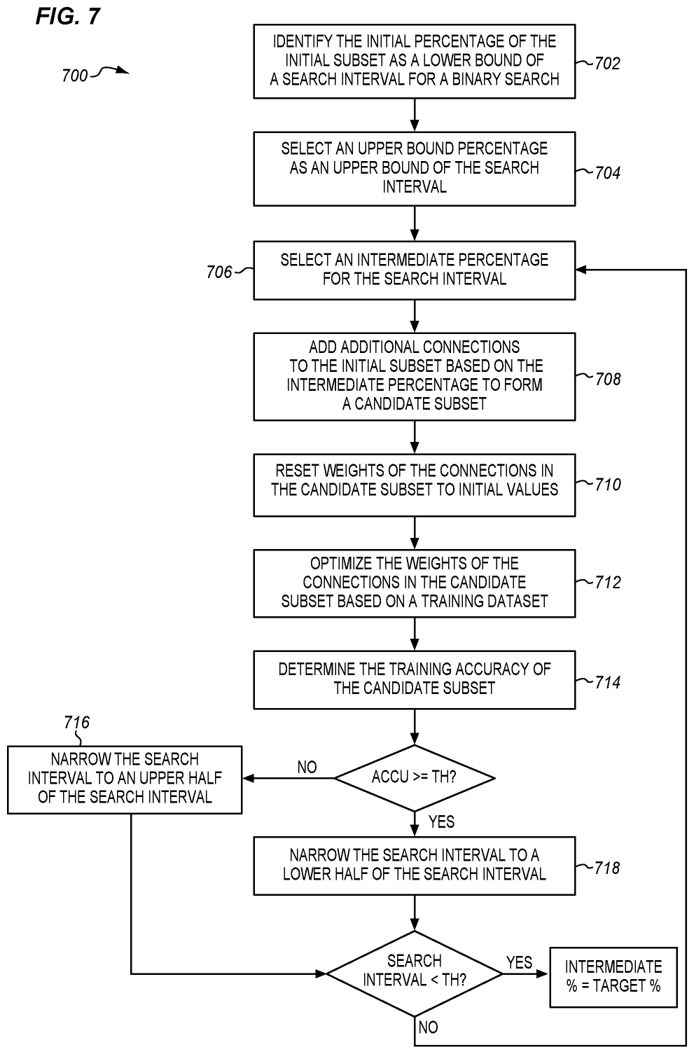

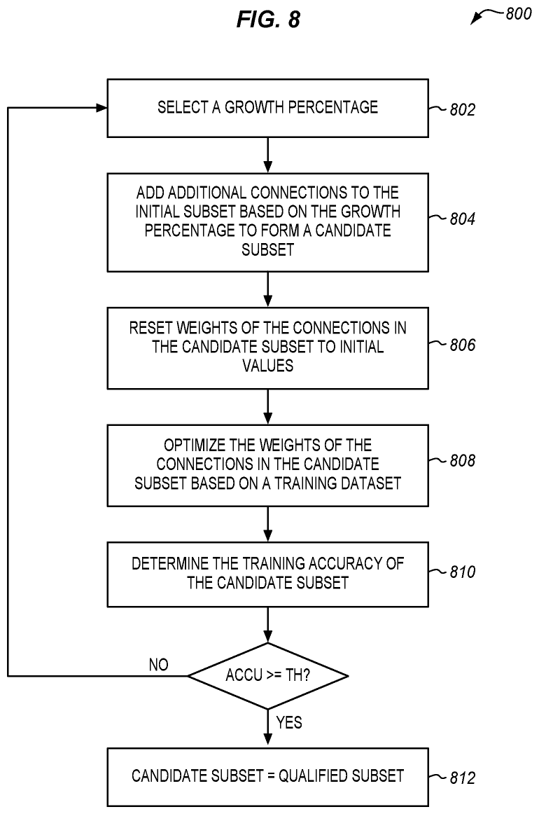

FIG. 7 is a flow chart illustrating a growth process 700 in an illustrative embodiment. The growth process 700 in this embodiment uses a binary search to identify the target percentage 621 for the qualified subset 620. In general, a binary search repeatedly divides a search interval in half. If a search item is less than the middle item of the search interval, then the search interval is narrowed to the lower half. Otherwise, the search interview is narrowed to the upper half. This process is repeated until the search item is found.

The initial subset 610 selected above has a training accuracy below the accuracy threshold. Thus, growth subsystem 404 identifies the initial percentage 611 of the initial subset 610 as a lower bound of the search interval for the binary search (step 702). Growth subsystem 404 then establishes or selects an upper bound of the search interval for the binary search (step 704). The upper bound comprises a percentage that is larger than the initial percentage 611, which is referred to generally as an upper bound percentage. The upper bound percentage is selected to have a training accuracy that reaches the accuracy threshold. For example, the upper bound percentage may be 100% of the connections 112, 90% of the connections 112, 50% of the connections 112, or some other percentage that reaches the accuracy threshold. Thus, the search interval for the binary search is initially between the lower bound defined by the initial percentage, and the upper bound defined by the upper bound percentage.

Growth subsystem 404 then searches for a target percentage 621 between the upper and lower bounds. To do so, subnetwork discovery system 400 selects, determines, or identifies an intermediate percentage for the search interval (step 706). The intermediate percentage comprises a midpoint of the search interval. Initially, the intermediate percentage is between the lower bound defined by the initial percentage 611, and the upper bound defined by the upper bound percentage. Growth subsystem 404 then adds additional connections 112 to the initial subset 610 based on the intermediate percentage to form a candidate subset of connections 112 (step 708). Growth subsystem 404 randomly selects additional connections 112 from DNN 100 and adds the additional connections 112 to the initial subset 610 to form the candidate subset that contains the intermediate percentage of connections 112 and associated weights 202.

Training subsystem 406 resets the weights 202 of the connections 112 in the candidate subset to initial values 602 (step 710). Training subsystem 406 then optimizes or adjusts the weights 202 of the connections 112 in the candidate subset based on a training dataset 410 (step 712), such as with an optimization algorithm (e.g., stochastic gradient descent). After training the candidate subset based on a training dataset 410, growth subsystem 404 determines the training accuracy of the candidate subset (step 714). When the training accuracy is below the accuracy threshold (e.g., 90%), growth subsystem 404 narrows the search interval to an upper half of the search interval (step 716). When the training accuracy meets (i.e., is equal to or greater than) the accuracy threshold, growth subsystem 404 narrows the search interval to a lower half of the search interval (step 718).

When the search interval is above a threshold, subnetwork discovery system 400 repeats steps 706-718. When the search interval becomes sufficiently small and is below a threshold (e.g., 1%, 2%, etc.), subnetwork discovery system 400 has converged on a target percentage 621 of connections 112 from DNN 100 for the qualified subset 620 (see also, FIG. 6). When the initial subset 610 is grown to contain a number of connections 112 equal to the target percentage 621, the resultant qualified subset 620 has a training accuracy that reaches the accuracy threshold.

FIG. 8 is a flow chart illustrating a growth process 800 in an illustrative embodiment. The growth process 800 in this embodiment iteratively builds the initial subset 610 until a qualified subset 620 is discovered having a training accuracy that reaches the accuracy threshold. Growth subsystem 404 selects, identifies, or determines a growth percentage (step 802), and adds additional connections 112 to the initial subset 610 based on the growth percentage to form a candidate subset of connections 112 (step 804). Growth subsystem 404 randomly selects additional connections 112 from DNN 100 based on the growth percentage, and adds the additional connections 112 to the initial subset 610 to form the candidate subset. The candidate subset therefore contains the connections 112 initially selected for the initial subset 610, and the additional connections 112 and their associated weights 202. The growth percentage may be selected based on a desired growth rate of the initial subset 610. For example, the growth percentage may be 1%, 2%, 5%, etc.

Training subsystem 406 resets the weights 202 of the connections 112 in the candidate subset to the initial values 602 (step 806). Training subsystem 406 then optimizes or adjusts the weights 202 of the connections 112 in the candidate subset based on training dataset 410 (step 808), such as with an optimization algorithm (e.g., stochastic gradient descent). After training the candidate subset based on a training dataset 410, growth subsystem 404 determines the training accuracy of the candidate subset (step 810). When the training accuracy reaches the accuracy threshold, growth subsystem 404 identifies the candidate subset as a qualified subset 620 (step 812). When the training accuracy is below the accuracy threshold, growth subsystem 404 initiates another iteration where process 800 returns to step 802. Growth subsystem 404 may perform multiple iterations of process 800 to grow the initial subset 610 until it contains a sufficient number of connections 112 to form a qualified subset 620 that, after training, has a training accuracy that reaches the accuracy threshold.

In one embodiment, growth subsystem 404 may use the same growth percentage for each iteration of process 800. In another embodiment, growth subsystem 404 may increase the growth percentage for successive iterations of process 800. For example, growth subsystem 404 may double the growth percentage for successive iterations of process 800. In another embodiment, growth subsystem 404 may decrease the growth percentage for successive iterations of process 800. For example, growth subsystem 404 may divide the growth percentage in half for successive iterations of process 800.

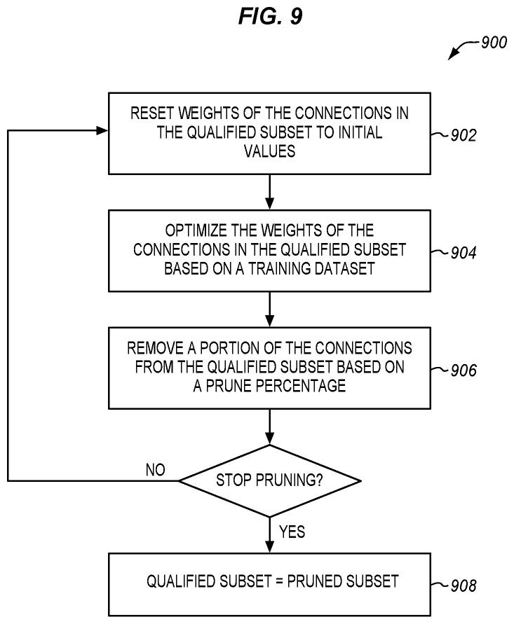

FIG. 9 is a flow chart illustrating a pruning process 900 in an illustrative embodiment. The pruning process 900 in this embodiment iteratively (or repeatedly) removes or masks a percentage of the connections 112 from a qualified subset 620 until a pruned subset 630 is discovered having a training accuracy that reaches the accuracy threshold. Training subsystem 406 resets the weights 202 of the connections 112 in the qualified subset 620 to the initial values 602 (step 902). Training subsystem 406 then optimizes or adjusts the weights 202 of the connections 112 in the qualified subset 620 based on a training dataset 410 (step 904), such as with an optimization algorithm (e.g., stochastic gradient descent). After training, pruning subsystem 408 removes or masks a portion of the connections 112 from the qualified subset 620 based on a prune percentage (step 906). The prune percentage may be selected based on a desired pruning rate of the qualified subset 620 to remove the smallest-magnitude weights. For example, the pruning percentage may be 1%, 2%, 5%, etc. Pruning subsystem 408 may then determine when to terminate the pruning process. When the determination is to terminate the pruning process, pruning subsystem 408 identifies the qualified subset 620 as a pruned subset 630 (step 908). When the determination is not to terminate the pruning process, pruning subsystem 408 initiates another iteration where process 900 returns to step 902. Pruning subsystem 408 may perform multiple iterations of process 900 to prune the qualified subset 620 and form pruned subset 630 that, after training, has a training accuracy that reaches the accuracy threshold.

Any of the various elements or modules shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

As used in this application, the term “circuitry” may refer to one or more or all of the following:

(a) hardware-only circuit implementations (such as implementations in only analog and/or digital circuitry);

(b) combinations of hardware circuits and software, such as (as applicable):
(i) a combination of analog and/or digital hardware circuit(s) with software/firmware; and
(ii) any portions of hardware processor(s) with software (including digital signal processor(s)), software, and memory(ies) that work together to cause an apparatus, such as a mobile phone or server, to perform various functions); and

(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although specific embodiments were described herein, the scope of the disclosure is not limited to those specific embodiments. The scope of the disclosure is defined by the following claims and any equivalents thereof

What is claimed is:

1. A subnetwork discovery system for a Deep Neural Network (DNN) comprising a plurality of nodes with connections between the nodes, the subnetwork discovery system comprising:
at least one processor and memory;
the at least one processor causes the subnetwork discovery system to:
initialize the DNN by assigning initial values to weights associated with the connections;
identify an initial subset of the connections randomly selected from the DNN, wherein the initial subset after training with a training dataset has a training accuracy below an accuracy threshold; and
perform a growth process by adding additional connections from the DNN to the initial subset to generate a qualified subset of the connections, wherein the qualified subset of the connections after training with the training dataset has a training accuracy that reaches the accuracy threshold.

2. The subnetwork discovery system of claim 1 wherein the at least one processor causes the subnetwork discovery system to:
perform a pruning process to remove a portion of the connections from the qualified subset to generate a pruned subset of the connections, wherein the pruned subset after training with the training dataset has a training accuracy that reaches the accuracy threshold.

3. The subnetwork discovery system of claim 2 wherein for the pruning process, the at least one processor causes the subnetwork discovery system to:
reset the weights of the connections in the qualified subset to the initial values;
optimize the weights of the connections in the qualified subset based on the training dataset; and
remove a portion of the connections from the qualified subset based on a prune percentage.

4. The subnetwork discovery system of claim 3 wherein the at least one processor causes the subnetwork discovery system to:
perform multiple iterations of the pruning process.

5. The subnetwork discovery system of claim 1 wherein:
the initial subset contains an initial percentage of the connections in the DNN;
the qualified subset contains a target percentage of the connections of the DNN; and
for the growth process, the at least one processor causes the subnetwork discovery system to use a binary search to identify the target percentage for the qualified subset.

6. The subnetwork discovery system of claim 5 wherein for the binary search, the at least one processor causes the subnetwork discovery system to:
(a) identify the initial percentage as a lower bound of a search interval for the binary search;
(b) select an upper bound of the search interval for the binary search as an upper bound percentage that is larger than the initial percentage;
(c) select an intermediate percentage for the search interval;
(d) add additional connections from the DNN to the initial subset based on the intermediate percentage to form a candidate subset of the connections;
(e) reset the weights of the connections in the candidate subset to the initial values;
(f) optimize the weights of the connections in the candidate subset based on the training dataset;
(g) determine a training accuracy of the candidate subset;
(h) narrow the search interval to an upper half of the search interval when the training accuracy is below the accuracy threshold; and
(i) narrow the search interval to a lower half of the search interval when the training accuracy meets the accuracy threshold; and
repeat (c)-(i) to converge on the target percentage.

7. The subnetwork discovery system of claim 1 wherein for the growth process, the at least one processor causes the subnetwork discovery system to:
select a growth percentage;
add additional connections to the initial subset based on the growth percentage to form a candidate subset of the connections;
reset the weights of the connections in the candidate subset to the initial values;
optimize the weights of the connections in the candidate subset based on the training dataset;
determine the training accuracy of the candidate subset;
identify the candidate subset as the qualified subset when the training accuracy reaches the accuracy threshold; and
initiate another iteration of the growth process when the training accuracy is below the accuracy threshold.

8. The subnetwork discovery system of claim 1 wherein:
the initial subset contains an initial percentage of the connections in the DNN; and
the at least one processor causes the subnetwork discovery system to:
select the initial percentage based on a ratio of a size of the training dataset, and a total number of the weights in the DNN.

9. A method of processing a Deep Neural Network (DNN) comprising a plurality of nodes with connections between the nodes, the method comprising:
initializing the DNN by assigning initial values to weights associated with the connections;
identifying an initial subset of the connections randomly selected from the DNN, wherein the initial subset after training with a training dataset has a training accuracy below an accuracy threshold; and
performing a growth process by adding additional connections from the DNN to the initial subset to generate a qualified subset of the connections, wherein the qualified subset of the connections after training with the training dataset has a training accuracy that reaches the accuracy threshold.

10. The method of claim 9 further comprising:
performing a pruning process to remove a portion of the connections from the qualified subset to generate a pruned subset of the connections, wherein the pruned subset after training with the training dataset has a training accuracy that reaches the accuracy threshold.

11. The method of claim 10 wherein for the pruning process, the method further comprises:
resetting the weights of the connections in the qualified subset to the initial values;
optimizing the weights of the connections in the qualified subset based on the training dataset; and
removing a portion of the connections from the qualified subset based on a prune percentage.

12. The method of claim 11 further comprising:
performing multiple iterations of the pruning process.

13. The method of claim 9 wherein:
the initial subset contains an initial percentage of the connections in the DNN;
the qualified subset contains a target percentage of the connections of the DNN; and
for the growth process, the method uses a binary search to identify the target percentage for the qualified subset.

14. The method of claim 13 wherein for the binary search, the method further comprises:
(a) identifying the initial percentage as a lower bound of a search interval for the binary search;
(b) selecting an upper bound of the search interval for the binary search as an upper bound percentage that is larger than the initial percentage;
(c) selecting an intermediate percentage for the search interval;
(d) adding additional connections from the DNN to the initial subset based on the intermediate percentage to form a candidate subset of the connections;
(e) resetting the weights of the connections in the candidate subset to the initial values;
(f) optimizing the weights of the connections in the candidate subset based on the training dataset;
(g) determining a training accuracy of the candidate subset;
(h) narrowing the search interval to an upper half of the search interval when the training accuracy is below the accuracy threshold; and
(i) narrowing the search interval to a lower half of the search interval when the training accuracy meets the accuracy threshold; and
repeating (c)-(i) to converge on the target percentage.

15. The method of claim 9 wherein for the growth process, the method further comprises:
selecting a growth percentage;
adding additional connections to the initial subset based on the growth percentage to form a candidate subset of the connections;
resetting the weights of the connections in the candidate subset to the initial values;
optimizing the weights of the connections in the candidate subset based on the training dataset;
determining the training accuracy of the candidate subset;
identifying the candidate subset as the qualified subset when the training accuracy reaches the accuracy threshold; and
initiating another iteration of the growth process when the training accuracy is below the accuracy threshold.

16. The method of claim 9 wherein:
the initial subset contains an initial percentage of the connections in the DNN; and
the method further comprises:
selecting the initial percentage based on a ratio of a size of the training dataset, and a total number of the weights in the DNN.

17. A non-transitory computer readable medium embodying programmed instructions executed by a processor, wherein the instructions direct the processor to implement a method of processing a Deep Neural Network (DNN) comprising a plurality of nodes with connections between the nodes, the method comprising:
initializing the DNN by assigning initial values to weights associated with the connections;
identifying an initial subset of the connections randomly selected from the DNN, wherein the initial subset after training with a training dataset has a training accuracy below an accuracy threshold; and
performing a growth process by adding additional connections from the DNN to the initial subset to generate a qualified subset of the connections, wherein the qualified subset of the connections after training with the training dataset has a training accuracy that reaches the accuracy threshold.

18. The computer readable medium of claim 17, wherein the method further comprises:
performing a pruning process to remove a portion of the connections from the qualified subset to generate a pruned subset of the connections, wherein the pruned subset after training with the training dataset has a training accuracy that reaches the accuracy threshold.

19. The computer readable medium of claim 17 wherein:
the initial subset contains an initial percentage of the connections in the DNN;
the qualified subset contains a target percentage of the connections of the DNN; and
for the growth process, the method uses a binary search to identify the target percentage for the qualified subset;
wherein for the binary search, the method further comprises:
(a) identifying the initial percentage as a lower bound of a search interval for the binary search;
(b) selecting an upper bound of the search interval for the binary search as an upper bound percentage that is larger than the initial percentage;
(c) selecting an intermediate percentage for the search interval;
(d) adding additional connections from the DNN to the initial subset based on the intermediate percentage to form a candidate subset of the connections;
(e) resetting the weights of the connections in the candidate subset to the initial values;
(f) optimizing the weights of the connections in the candidate subset based on the training dataset;
(g) determining a training accuracy of the candidate subset;
(h) narrowing the search interval to an upper half of the search interval when the training accuracy is below the accuracy threshold; and
(i) narrowing the search interval to a lower half of the search interval when the training accuracy meets the accuracy threshold; and
repeating (c)-(i) to converge on the target percentage.

20. The computer readable medium of claim 17 wherein for the growth process, the method further comprises:
selecting a growth percentage;
adding additional connections to the initial subset based on the growth percentage to form a candidate subset of the connections;
resetting the weights of the connections in the candidate subset to the initial values;
optimizing the weights of the connections in the candidate subset based on the training dataset;
determining the training accuracy of the candidate subset;
identifying the candidate subset as the qualified subset when the training accuracy reaches the accuracy threshold; and
initiating another iteration of the growth process when the training accuracy is below the accuracy threshold.
